(19) United States
(12) Patent Application Publication
(10) Pub. No.: US 2008/0252142 A1
(43) Pub. Date: Oct. 16, 2008

(54) Apparatus for Electrical Power Transmission

(75) Inventors: Mark Davies, Howrah (AU); Jorg Dorn, Butttenheim (DE); Hartmut Huang, Erlangen (DE); Dietmar Retzmann, Hochstadt (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/066,275

(22) PCT Filed: Sep. 9, 2005
(86) PCT No.: PCT/DE2005/001602

§ 371 Date: Mar. 10, 2008

(51) Int. Cl. H02J 3/36

(52) U.S. Cl. 307/42

(57) ABSTRACT

A device for electrical energy transmission includes one or more current converters. Each current converter has phase elements with at least one series connection of circuit elements each with at least two power semiconductors and at least two free-wheeling diodes that are connected in parallel thereto, and energy storing means. The transfer properties in or between power distribution networks are improved with the novel device. The phase elements have at least two parallel branches that are connected in parallel with each other and each having with a series connection of circuit elements.

The invention relates to an apparatus for electrical power transmission having at least one converter, with each converter having phase elements, which each have at least one series circuit of switching elements, which each have at least two power semiconductors which can be switched off, and at least two freewheeling diodes, which are in each case connected in parallel with them, and energy storage means.

One such apparatus is already known from DE 101 03 031 A1, which discloses a converter which has a multiplicity of capacitors as an energy store, which have individual associated switching elements. In this case, the switching elements have power semiconductors which can be switched off, with freewheeling diodes connected in parallel. The use of a multiplicity of capacitors which can be connected individually allows the voltage which can be produced by the converter to be regulated, which regulation is more accurate, or in other words finer, than voltage regulation of a converter whose switching elements interact with a central energy store, which is common to all the switching elements.

In the power distribution field, it is normal practice to connect converters to one another on the DC voltage side to form a back-to-back link, and to couple them on the AC side to a first and/or a second transmission system. The transmission systems, which are connected to one another via the back-to-back link, may for example be at different voltage levels, at different frequencies, phase angles or star-point connections. The power and/or the wattless component can be transmitted specifically within or between the first and the second power transmission system by suitable control of the back-to-back link.

In addition to back-to-back links, converters are used in the field of power transmission and distribution in so-called high-voltage direct-current transmission (HVDC) installations and so-called flexible AC transmission systems (FACTS). When used in this way, the converters have power semiconductors, for example thyristors, which operate using a mains-commutated technique. However, power semiconductors which can be switched off, for example so-called insulated gate bipolar transistors (IGBT) using self-commutated topology, are also used. In the case of so-called voltage sourced converters (VSC) with power semiconductors which can be switched off, an intermediate energy store, generally a capacitor, is required. Arrangements with self-commutated converters and a capacitor as an intermediate energy store have the disadvantage that the power which could be transmitted is limited by size of the capacitor that is used. In the event of a fault, an extremely high short-circuit current can lead to destruction of the installation. Until now, only transmission voltages up to about +150 kV and transmission power levels from about 300 to 500 Megawatts have been handled in practice with an arrangement such as this.

The object of the present invention is to provide an apparatus of the type mentioned initially which allow the voltage which can be produced by the converter to be regulated even more finely.

The invention achieves this object in that the phase elements each have at least two parallel branches which are connected in parallel with one another and each have a series circuit of switching elements.

According to the invention, each phase element has at least two parallel branches. Each parallel branch comprises a series circuit formed by switching elements which have an associated energy storage means. According to the invention, the capacitance or capacity which is required for the converter can therefore be split between a relatively large number of energy storage means which can be connected individually. This allows even more accurate regulation or, in other words, finer graduation of the voltage which can be produced by the converter. The voltage, which can be graduated finely, can be used for any desired applications within the scope of the invention. For example, the apparatus according to the invention is connected to a load connection or to a transmission system. The transmission system has one or more phases and is intended to carry an AC voltage. For the purposes of the claimed invention, an AC voltage should be understood as meaning both a fundamental frequency variable and a voltage profile which varies in an undefined manner over time.

The configuration and the operation of the switching elements are described DE 101 03 031 A1, which is hereby defined as an entire part of the present disclosure. One advantageous feature of switching elements such as these being connected in series is that the stored energy is distributed over a multiplicity of respectively smaller energy storage means, so that the voltage and power limit of an arrangement formed by a single energy storage means, for example a capacitor, is overcome. Furthermore, the distributed energy storage means finer graduation of the voltage produced by the converter in comparison to apparatuses having only one common energy store, thus reducing the complexity for smoothing and filtering at the connection point of the apparatus. For example, this considerably simplifies the coupling of the converter to a transmission system or to a load. The invention avoids the need for complex magnetic coupling measures, for example by transformer windings connected in series. Furthermore, the invention ensures increased operational safety and reliability since, in the event of failure of a single switching elements, for example as a result of a short circuit, the other switching elements remain operable, as before. The individual switching elements of a phase element act like controllable voltage sources, and have three possible states. In a first state, the terminal voltage of the switching element is equal to the capacitor voltage. In a second state, the terminal voltage of the switching elements is virtually equal to zero, apart from the forward voltage across the power semiconductor which can be switched off or across the freewheeling diode, with a third state being provided for malfunctions.

According to the invention, the apparatus is of modular design. The modular design is achieved by phase elements, which are in turn subdivided into switching elements. The switching elements are either identical or, in particular, are designed with identical energy storage means, which therefore have the same storage capacitance or capacity. In contrast to this, however, combinations with a different configuration of the capacitance or capacity are also within the scope of the invention.

In expedient further development of the invention, each parallel branch has a even number of switching elements, with a connection for connection of the respective phase element to a load or to a transmission system being connected centrally to the parallel branches. A connection arranged centrally in the series circuit is predicated on an even number of switching elements. In this case, all the switching elements are physically identical. In other words, each phase element is designed to be symmetrical with respect to the connection. The switching elements on one side of the series circuit of a symmetrical phase element are, for example, in a first state, as described further above, and the switching elements on the other side are in the second state, likewise as described further above, or vice versa. These drives then result in the maximum voltage values. If one or more switching elements on the respective sides are switched to the respective other state, this results in a graduated reduction in the voltage by the step point of the voltage of the individual switching elements.

However, phase elements with an odd number of switching elements and/or phase elements and with a non-central load or power supply system connection are also within the scope of the invention. The individual switching elements are, for example, designed for equal or unequal voltages and are expediently graduated differently, in a binary form or some other form, therefore allowing finer adjustment with the same number of switching elements than one design for equal voltages.

In one expedient development, a plurality of phase elements of a converter are connected in parallel with one another. In this case, the phase elements form a bridge circuit. The converter acts like a so-called voltage sourced converter (VSC), that is known per se, and can advantageously be coupled to a transmission system, to a DC voltage line or to load. In this case, by way of example, the converter generates a polyphase AC voltage. The zero phase angle and/or the amplitude of the AC voltage to be fed into the transmission system can be influenced selectively by expedient control means, to be precise independently of one another. The expression zero phase angle means the phase difference between the AC voltage and a reference variable, which is dependent on the respective requirements to which the apparatus according to the invention is subject. The alternating current of the transmission system at the connection point is therefore mentioned just by way of example here as a reference variable. By way of example, a converter such as this can therefore also be used as an active filter element instead of or combined with passive filters, such as RC elements, for active filtering of the voltage distortion in the frequency range below and/or above the power supply system frequency (subharmonics, supersubharmonics), and/or to compensate for unbalanced voltages. In this case, a voltage such as this is fed in by the converter in such a way that the voltage discrepancies from a sinusoidal waveform are cancelled out, for example, by negative interference.

One advantageous feature of the use of a converter according to the invention with three phase elements connected in parallel with one another is that no energy storage means need be connected to the DC voltage line on the DC voltage side, since the individual switching elements of the phase elements themselves have energy storage means which are used not only as energy store but also to smooth the voltage on the DC voltage side. The use of three phase elements connected in parallel with one another in two converters, together with the switching elements with energy storage means, makes it possible to produce a polyphase AC voltage which can be graduated more finely, for example for feeding into a connected AC voltage power supply system.

Furthermore, a voltage sourced converter such as this can also be used as a converter for direct-current transmission. By way of example, the converter then has three phase elements, connected in parallel with one another, in a known bridge circuit. An arrangement with two parallel-connected phase elements also provides a simple capability to configure a converter for direct-current transmission for connection to a transmission system having just one single phase, for example via a coupling transformer, or to a transmission system having a plurality of phases. The expression direct-current transmission includes, for the purposes of the invention, both high-voltage direct-current transmission (HVDC) and medium-voltage direct-current transmission (MVDC) as well as low-voltage direct-current transmission (LVDC).

In another embodiment, a plurality of phase elements are connected in series with one another. An arrangement such as this likewise acts as a voltage sourced converter and may, for example, act as a converter in a direct-current transmission installation. In this case, the series circuit allows transmission at a higher DC voltage, that is to say with a reduced current and therefore reduced losses, for a predetermined power level.

In one advantageous development, energy storage means are arranged in parallel with the phase elements. Such additional energy storage means are used to provide further smoothing and stabilization.

In a further refinement, each phase element has at least one impedance or is connected to another phase element via at least one impedance. Impedances such as these, in the simplest case in the form of coils, advantageously delimit any circulating current, which may occur between the individual phase elements, for example because of voltage fluctuations or unbalanced voltages. Furthermore, the impedances can be designed such that the rate of current rise and/or the current amplitude are/is limited in the event of malfunctions. The impedance is in this case, by way of example, either connected in series with the phase element or with individual switching elements of a phase element or is integrated in the switching elements, for example using an advantageous modular design.

In one preferred embodiment, at least one converter can be connected in parallel to a transmission system or a DC voltage line. An arrangement such as this is used for so-called parallel compensation for control of the wattless component and/or the power and, for example, provides dynamic control functions for damping undesirable power oscillations and/or sub-synchronous resonances and/or subharmonics or supersubharmonics. The advantageous further development is also used, for example, for voltage balancing. The further-developed apparatus according to the invention is particularly advantageous in comparison to known parallel compensation apparatuses in that the series circuit of the switching element which has already been described above makes it possible to feed an AC voltage which can be graduated finely into the transmission line, with the energy for production of the AC voltage being stored in the distributed energy storage means of the individual switching elements, in contrast to known apparatuses in which a single capacitor is used as the energy store and which, because of its size, acts as a limiting element for the transmission voltage and power of the apparatus. The apparatus according to the invention with energy storage means in each switching element therefore makes it possible to set the voltage to be fed in more finely.

In a further refinement, at least one converter can be connected in series with the transmission system. A connection such as this is likewise used to control the wattless component and/or the power of the transmission system, including the already described dynamic control function, by actively connecting and/or feeding in a voltage whose magnitude and/or phase are dynamically variable. The apparatus according to the invention advantageously has a plurality of converters, one of which is connected in parallel with the transmission system, and the other is connected in series. The wattless component and/or power in the transmission system are/is controlled, or else the dynamic control functions as described above are improved by actively feeding in two voltages whose magnitude and/or phase are dynamically variable. By way of example, the transmission system is a single-phase or polyphase transmission line.

In a different environment, each converter is connected to a DC voltage source. According to this expedient further development, a DC voltage can be produced between the DC voltage source and the converter. The converter is the used to convert a DC voltage to an AC voltage. However, the way in which a converter acts as a rectifier or inverter can be chosen as required.

According to one expedient further development relating to this, the DC voltage source is a rectifying converter. According to this advantageous further development, two converters are provided, for example. The two converters then operate as converter, whose DC voltage sides are connected to one another in a direct-current transmission installation or a back-to-back link. The power and/or wattless component to be transmitted and/or the respective proportions of each of them can be determined by expedient control of the converters.

The rectifying converter is advantageously connected to at least two converters. An apparatus such as this is also referred to as a multiterminal apparatus.

The converters are advantageously connected directly to one another, forming a back-to-back link. An apparatus such as this is also referred to a as back-to-back direct-current transmission installation. The back-to-back link for the purposes of the invention comprises, for example, two converters which are connected to one another on the DC voltage side. In contrast to this, the back-to-back link has a plurality of converters which are connected to one another on the DC voltage side. A multiterminal back-to-back link such as this makes it possible, for example, to connect a plurality of transmission systems, with load flow between the power supply systems being specifically controllable.

According to one exemplary embodiment, which differs from this, the converters are connected to one another by means of a DC voltage line. This results in a so-called direct-current long-distance transmission installation. The direct-current long-distance transmission installation may likewise have just two or else a plurality of converters. The nominal parameter for control purposes in the case of converters which are installed a long distance apart from one another are transmitted by expedient long-distance data transmission between the converters. The converters for a direct-current long-distance transmission installation such as this are advantageously installed several kilometers away from one another.

In one expedient further development, the DC voltage line has one or two poles. Two-pole DC voltage lines allow higher power levels to be transmitted. Single-pole DC voltage lines, which pass the direct current back via ground or through the water in the case of underwater cable links lead to low-cost apparatuses. Single or two-phase transmission systems on the alternating-current side of the direct-current long-distance transmission installation according to the invention allow a connection to special power systems, for example to rail road power supplies. Multipole DC voltage lines are, of course, possible within the scope of the invention. DC voltage transmission is in principle carried out using a DC voltage line of any desired configuration.

However, the DC voltage line is advantageously at least partially a gas-insulated transmission line, a cable and/or an overhead line. Combinations of these lines are, of course, also possible within the scope of the invention. The particular advantage of a gas-insulated transmission line, GIL, over a cable, in conjunction with an overhead line as well, is the capability to cope better with dynamic control and protection functions because of the reduced charge capacitance of the gas-insulated line. An apparatus according to the invention which has been developed further in this way is used, for example, for direct-current long-distance transmission, in order to produce a DC voltage by means of a first rectifier from single-phase or polyphase AC voltages.

In a further embodiment of this further development, the DC voltage line is formed by an impedance, in the simplest case by a coil. With a coil as the DC voltage line, for example, a so-called back-to-back link which is known per se can be formed, with the coil carrying out functions such as smoothing, current limiting and/or rise-gradient limiting.

In one expedient refinement, one of the converters uses mains-commutated power semiconductors. The embodiment of the apparatus with a converter which, for example, has a bridge circuit composed of mains-commutated power semiconductors, for example thyristors or in the simplest case even diodes instead of the power semiconductor which can be switched off, allows the installation costs to be reduced.

In one expedient refinement, a further diode is connected in parallel with each of the switching elements. A further diode such as this, for example a pressure-contact diode which is known per se, such as a disc cell diode or a diode integrated in a pressure-contact electronics module can result in a defective switching element being bridged if one or more of the switching elements is or are faulty, assuming appropriate drive by the control system, thus allowing further operation of the converter. In this case, a brief overvoltage is built up deliberately across the defective switching element by suitably driving the switching elements which are still intact, so that the parallel-connected diode is broken through and the defective switching element is permanently bridged until replacement during the next maintenance cycle.

Furthermore, the freewheeling diode which is integrated in the power semiconductor can also have a bridging function such as this for the switching element in the event of a malfunction.

On the basis of the terminology chosen here, energy storage means comprise energy stores such as batteries, a flywheel, supercaps or capacitors. Energy stores have a considerably higher energy density than capacitors. This has the advantage that the wattless component and/or the power can be controlled, including the already described dynamic control functions, are still available even in the event of a relatively long voltage dip or failure in the transmission system or in the DC voltage line. The use of energy storage means with a high energy density results in improved system availability.

The energy storage means are advantageously at least partially capacitors. Capacitors cost little in comparison with the currently known energy stores.

At least two parallel branches are advantageously connected to one another by means of a transformer winding. In contrast to this, at least two parallel branches are galvanically connected to one another via a parallel branch connection. The galvanic connection by means of a parallel branch connection allows a low-cost transformer design, which is used for connection of the apparatus according to the invention to a transmission system or to a load.

In one preferred embodiment, the converters are connected to the DC voltage line by means of an energy store. When using energy stores with a high energy density, a connection such as this results in better system availability. By way of example, in this development according to the invention as well, the abovementioned energy stores may be used as energy stores, with the exception of supercaps. The energy stores are connected to the DC voltage line in series or in parallel.

The apparatus advantageously forms a direct-current transmission installation and/or a so-called FACTS (Flexible AC Transmission System) and in the process supplies a finely graduated output voltage. A further advantage is transmission of a wattless component and/or power without complex magnetic coupling. In this case, the apparatus according to the invention is advantageously of modular design. The apparatus according to the invention is used particularly preferably for direct-current transmission and/or to provide a so-called static synchronous compensator

(STATCOM), a static synchronous series compensator (S3C) or a unified power flow controller (UPFC).

Further expedient refinements and advantages of the invention are the subject matter of the following description of exemplary embodiments of the invention with reference to figures in the drawing, in which the same reference symbols refer to components with the same effect, and in which:

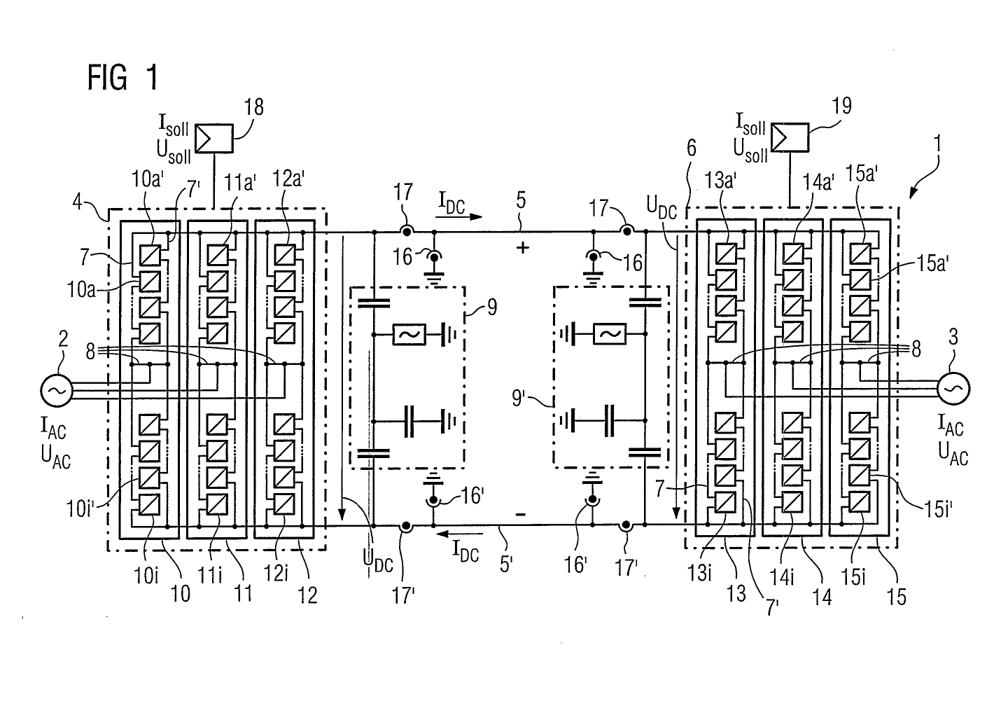

FIG. 1 shows a schematic illustration of one exemplary embodiment of the apparatus according to the invention,

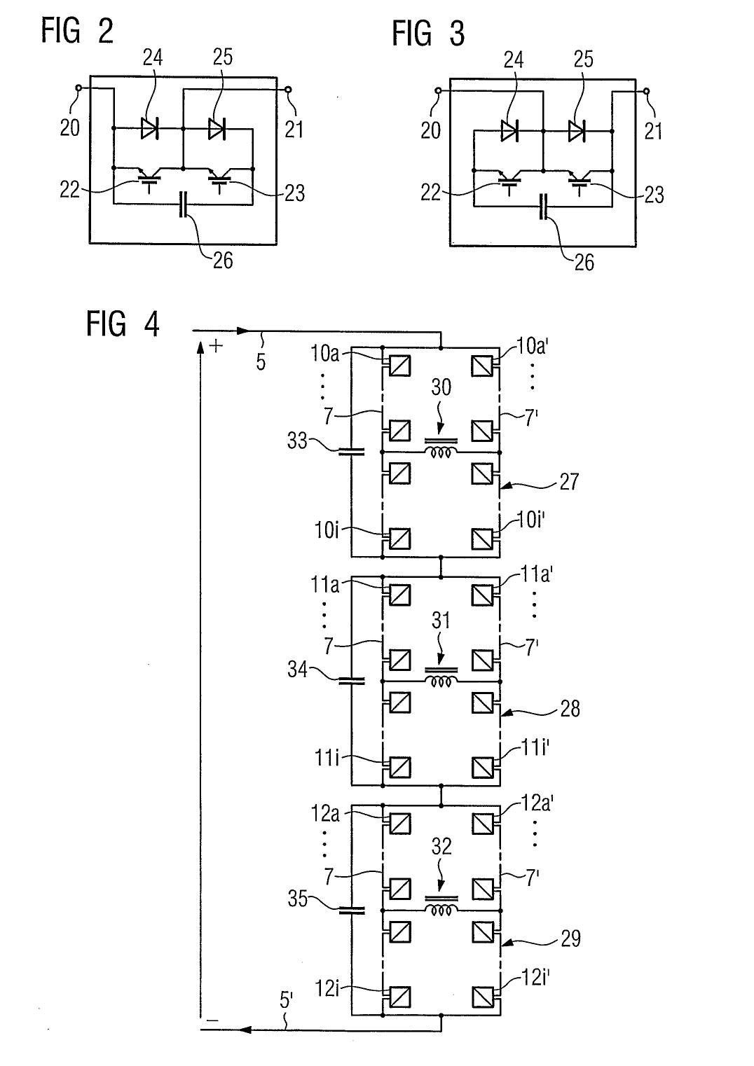

FIG. 2 shows a circuit arrangement of a switching element for the apparatus shown in FIG. 1,

FIG. 3 shows a further exemplary embodiment of a switching element in FIG. 1,

FIG. 4 shows an example of a schematic illustration of a converter with a series circuit of phase elements for the apparatus according to the invention,

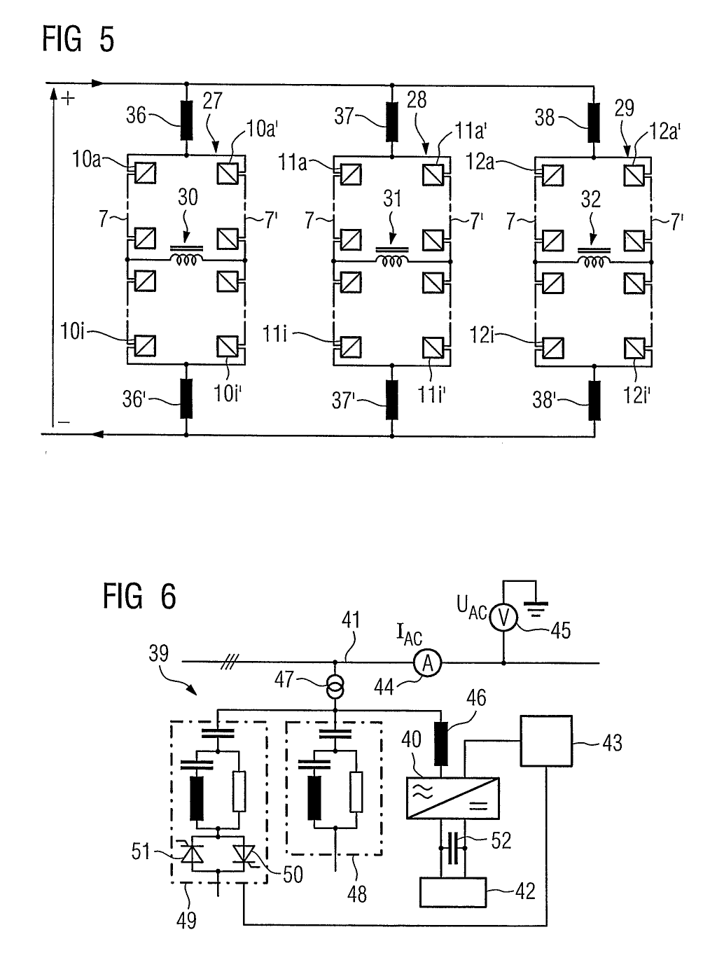

FIG. 5 shows an example of a schematic illustration of a converter with a parallel circuit of phase elements for the apparatus according to the invention, and

FIG. 6 shows a further exemplary embodiment of the apparatus according to the invention.

FIG. 1 shows a high-voltage back-to-back link 1 as an apparatus for electrical power transmission, for bidirectional power transmission from a transmission system or AC voltage power supply system 2 to another AC voltage power supply system 3. The AC voltage power supply systems 2 and 3 are in this case connected to the high-voltage back-to-back link 1 via transformers and/or coils, which are not illustrated, or galvanically to the high-voltage back-to-back link 1. The high-voltage back-to-back link 1 comprises a first converter 4 as a converter for conversion of the AC voltage to a DC voltage, a DC voltage connection 5 and a second converter 6 for conversion of the DC voltage to an AC voltage. The first converter 4 has three phase elements 10, 11, 12, which each comprise two parallel branches 7, 7′. Each parallel branch in turn comprises a multiplicity of switching elements 10a . . . 10i, 10a′ . . . 10i′, 11a . . . 11i, 11a′ . . . 11i′, and 12a . . . 12i, 12a′ . . . 12i′ which are arranged in series. In this case, for symmetry reasons, each phase element 10, 11, 12 is connected in the center of the series circuit of switching elements to in each case one phase of the AC voltage of the AC voltage power supply system 2. A parallel branch connection 8 is used for connection and is coupled via a transformer, which is not shown, to the AC voltage power supply system. The number of switching elements arranged between the parallel branch connection 8 and the positive connecting line 5 is precisely the same as the number of switching elements arranged between the parallel branch connection 8 and the negative connecting line 5′. The phase elements are therefore connected to the AC voltage power supply system 2 centrally.

The second converter 6 likewise has three phase elements 13, 14, 15, which likewise have two parallel branches 7, 7′. Once again, each parallel branch 7, 7′ comprises an even number of series-connected switching elements 13a . . . 13i, 13a′ . . . 13i′, 14a . . . 14i, 14a′ . . . 14i′, and 15a . . . 15i, 15a′ . . . 15i′, which each have a connection for one phase of the AC voltage power supply system 3, in the center of the series circuit. In this case as well, the connection is provided by a transformer, which is not illustrated in the figures.

The high-voltage back-to-back link 1 also has, at the respective ends of the DC voltage connection 5, 5′, further circuit arrangements, which are annotated 9 and 9′, respectively, composed of capacitors and/or coils and/or resistors and/or suppressors, which are arranged for additional smoothing of the DC voltage and for stabilization of the transmission.

Voltage transformers 16, 16′ as well as current transformers 17, 17′ are provided in order to respectively measure the voltage and current both on the DC voltage connection 5 and on the respective AC voltage power supply systems 2, 3, with the voltage transformers and current transformers on the alternating current side not being illustrated in the figures, for clarity reasons. The output signals from the voltage transformers 16, 16′ and from the current transformers 17, 17′ correspond to the respective measurement variable to be monitored on the high-voltage components. The recorded variables are, finally transmitted as measured values to control units 18, 19, for the high-voltage back-to-back link 1. The signals are sampled in the control units 18, 19 in order to obtain respectively associated sample values, and the sample values are digitized, in order to produce digital measured values. The measured digitized measured currents I_{DC} and/or I_{AC} and the measured digitized measured voltages U_{DC} and/or U_{AC} are compared with respective predetermined nominal values Iₙₒₘ and/or Uₙₒₘ, respectively. Means for controlling the apparatus control the converters 4 and 6 using open-loop and/or closed-loop control methods.

Further coils, which are not illustrated in the figures, may be arranged between the connections on the DC voltage sides of the phase elements 10, 11, 12 and 13, 14, 15 or in each case at the center connection, on the AC voltage side of the respective phase element. The coils limit any possible circulating current between the phase elements.

FIGS. 2 and 3 show equivalent circuit arrangements which are known from DE 101 03 031 A1 and are used as switching elements 10a . . . 10i, 11a . . . 11i, 12a . . . 12i, 13a . . . 13i, 14a . . . 14i, 15a . . . 15i and, respectively 10a′ . . . 10i′, 11a′ . . . 11i′, 12a′ . . . 12i′, 13a′ . . . 13i′, 14a′ . . . 14i′ and 15a′ . . . 15i′ in the apparatus shown in FIG. 1. The switching elements each have two connecting terminals 20, 21, two power semiconductors 22, 23, two diodes 24, 25 and a capacitor 26 as the energy storage means. The power semiconductors 22 and 23 in the illustrated example are electronic switches which can be switched off, and in this case are IGBTs. However, IGCTs, MOS switching-effect transistors or the like may also be used as power semiconductors. The operation of the circuit arrangement and of the series circuit comprising a plurality of such switching elements is described in DE 101 03 031 A1, which, by virtue of this reference, represents the subject matter of the present disclosure. The individual switching elements may be designed for the same or different voltage ranges, for example with the capability to be graduated differently, either in a binary form or in some other way. An additional diode, which is not illustrated in the figures, is connected as required to the connecting terminals 20, 21 and is used to bridge the switching element in the event of a malfunction.

FIG. 4 shows a further exemplary embodiment of a converter in a so-called H circuit for use in an apparatus according to the invention, in which the switching elements 10a . . . 10i and, respectively, 10a′. . . 10i′, 11a . . . 11a and, respectively, 11a′. . . 11i′, 12a . . . 12i and, respectively, 12a′. . . 12i′ shown in FIG. 2 are arranged to form phase elements 27, 28 and 29. Each of the phase elements 27, 28, 29 once again has two parallel branches 7, 7′, each having series-connected switching elements. The parallel branches are each connected to one another via two outer connecting lines, which are shown at the top and bottom in FIG. 4, and a central connecting line, with the same number of switching elements being connected in series between the central connecting line and each outer connecting line. The central connecting line in each case has a phase connection 30, 31, 32 for connection to two phases of a connected AC voltage. The phase connections 30, 31, 32 are illustrated schematically as connections on the secondary side of transformers 30, 31, 32, and on whose primary side, which is not illustrated, the respective AC voltage is tapped off or is applied. Capacitors 33, 34, 35 are connected in parallel with the respective phase elements 27, 28, 29, which are connected in series with one another. When the illustrated arrangement is operated in order to produce an AC voltage, each phase element uses the DC voltage fed in on the DC voltage side to feed an AC voltage into one phase of a polyphase AC voltage, by appropriately driving the individual switching elements. The capacitors 33, 34, 35 are used for additional stabilization and smoothing, and are provided only optionally. This arrangement operates on the principle of a voltage sourced converter and uses the DC voltage which is fed in on the DC voltage side or is produced by the converter itself to generate a three-phase AC voltage. The arrangement may, of course, also be used as a converter for conversion of a three-phase AC voltage to a DC voltage, and vice versa.

FIG. 5 shows a converter with a parallel circuit of the phase elements 27, 28, 29, by means of which higher transmission currents are achieved than with the series circuit shown in FIG. 4. The phase elements 27, 28, 29 in this embodiment are, for example, connected by means of respective coils 36, 37, 38 and 36′, 37′, 38′ to the bipolar direct-current circuit, to which a transmission line, a cable or a GIL, or any desired combination thereof, can be connected.

FIG. 6 shows, schematically, a further exemplary embodiment of the apparatus according to the invention for electrical power transmission 39. The apparatus 39 has a converter 40 which is connected to a transmission line 41, with the converter 40 being connected on the DC voltage side to a capacitor 52 and to an optional DC voltage source 42. The transmission line 41, as a transmission system, is part of a power supply system with a load connection.

Open-loop and closed-loop control are provided for the converter 40 not only by further means for controlling the illustrated apparatus 39 according to the invention but by an open-loop and closed-loop control unit 43 to which a measured alternating current I_{AC}, which is recorded by means of a current measurement unit 44, and a measured AC voltage U_{AC}, which is obtained by means of a voltage measurement unit 45, are transmitted and in which they are compared with predetermined nominal values in order to control the AC voltage on the transmission line 41 dynamically, and with matched phases, by means of suitable control methods. At this point, it should also be noted that the expression AC voltage covers any desired time profiles of the voltage which is applied to the transmission line 41 as the transmission system, and is not just limited to sinusoidal or harmonic voltage profiles.

The converter 40 is connected to the transmission line 41 via an optional coil 46 and a likewise optional transformer 47. The converter 40 allows the wattless-component and/or power control or dynamic control functions such as damping of power oscillations and/or subsynchronous resonances and/or the subharmonics and/or supersubharmonics, and/or voltage balancing by actively feeding in a voltage whose magnitude and/or phase are/is dynamically variable.

The converter 40 has phase elements which are not illustrated in the figures, like the converters 4, 6 shown in FIG. 1 or the converters illustrated in FIGS. 4 or 5. The apparatus has further assemblies for compensation 48, 49, which have fixed elements as well as switchable or controllable power semiconductors 50, 51, and are likewise connected to the transmission line 41. The passive components in the assemblies for compensation 48, 49 may comprise any desired combinations of coils, capacitors, resistors or suppressors and/or individual elements thereof. For example, it is advantageous to fit the assembly 49 with a resistor, thus providing a switched or controlled braking resistor for dissipating any excess power on the transmission line 41. Excess power such as this can lead to damaging overvoltages when loads or HVDC installations which are connected to the transmission line 41 are disconnected.

The assembly 49 advantageously has at least one suppressor. The fitting of this suppressor makes it possible to achieve a comparable voltage reduction. The connection of the converter 40 and of the assemblies for compensation 48, 49 to the polyphase transmission line 41 may be made via the transformer 47, via an impedance or else directly. Compensation and control elements such as these are known per se by the name FACTS. In the case of the apparatus according to the invention described here, the AC voltage generated in the converter 40 is actively applied to the transmission line 41. In this case, the converter 40 is driven as a function of the transmission requirements so that the signal which is fed in can be matched to the transmission requirements with a fine graduation. Instead of the power semiconductors 50, 51, it is also possible to use mechanical switches such as circuit breakers. In this case, the apparatus according to the invention has FACTS, which are known per se, for example a static synchronous compensator (STATCOM) and, for series coupling to the transmission line, a static synchronous series compensator (S3C) or, in the case of a combination of parallel and series coupling, a unified power flow controller (UPFC).

The apparatuses illustrated in FIGS. 1, 4, 5 and 6 may, within the scope of the invention but in contrast to the illustrated three-phase AC voltage power supply systems or the three-phase transmission line 41, be connected to single-phase, two phase or polyphase AC power supply systems or transmission lines by means of respective expedient connecting means.

Furthermore, the high-voltage back-to-back link 1 shown in FIG. 1 also has switching elements which are connected in series as shown in FIG. 4, in addition to the parallel circuit of the phase elements shown in FIG. 1, within the scope of the invention. An HVDC installation can be produced by using a DC voltage line which extends between the converters. Both an HVDC installation and a back-to-back link may have more than two converters and may be suitable for multiterminal operation, within the scope of the invention. By way of example, the transmission line between the converters is in the form of a cable or a gas-insulated transmission line. Direct connection of the converters results in said back-to-back link.

The capacitors in the circuit arrangement 9, 9′ illustrated in FIG. 1, the capacitors 26 shown in FIGS. 2 and 3, the capacitors 33, 34, 35 shown in FIG. 4 and the capacitors shown in FIG. 6 including the capacitor 52 may be combined as required with energy stores such as a flywheel, batteries, supercaps or the like, or may be replaced by these energy stores. For this purpose, the energy stores are arranged in parallel with or instead of said capacitors. A spatially concentrated arrangement in a common assembly, for example in the circuit arrangement 9, as well as a distributed arrangement of the energy stores, that is to say spatial splitting between different components, are also possible.

### LIST OF REFERENCE SYMBOLS

1 Back-to-back link

2, 3 AC voltage network

4 First converter

5, 5′ DC voltage connection

6 Second converter

7, 7′ Parallel branch

8 Parallel branch connection

9, 9′ Circuit arrangement

10, 11, 12 Phase elements

10a . . . 10i Switching elements

11a . . . 11i Switching elements

12a . . . 12i Switching elements

10a′ . . . 10i′ Switching elements

11a′ . . . 11i′ Switching elements

12a′ . . . 12i′ Switching elements

13, 14, 15 Phase elements

13a . . . 13i Switching elements

14a . . . 14i Switching elements

15a . . . 15i Switching elements

16, 16′ Voltage transformers

17, 17′ Current transformers

18, 19 Control unit

20, 21 Connections

22, 23 Power semiconductor

24, 25 Diodes

26 Capacitor

27, 28, 29 Phase elements

30, 31, 32 Phase connections

33, 34, 35 Capacitors

36, 37, 38 Coils

36′, 37′, 38′ Coils

39 System for electrical power transmission

40 Converter

41 Transmission line

42 Energy storage means

43 Open-loop and closed-loop control unit

44 Current measurement unit

45 Voltage measurement unit

46 Coil

47 Transformer

48, 49 Compensation assemblies

50, 51 Thyristors

52 Capacitor

1-21. (canceled)

22. An apparatus for electrical power transmission, comprising:
at least one converter, said at least one converter having phase elements each including at least one series circuit of switching elements each having at least two power semiconductors that can be switched off and at least two freewheeling diodes, respectively connected in parallel with said power semiconductors, and energy storage means;
said phase elements each having at least two parallel branches connected in parallel with one another and each including a series circuit of switching elements.

23. The apparatus according to claim 22, wherein each said parallel branch has an even number of said switching elements, and a connection for connecting the respective said phase element to a load or to a transmission system disposed centrally in said parallel branches.

24. The apparatus according to claim 22, wherein a plurality of said phase elements of a converter are connected in parallel with one another.

25. The apparatus according to claim 22, wherein a plurality of said phase elements are connected in series with one another.

26. The apparatus according to claim 22, which comprises energy storage means connected in parallel with said phase elements.

27. The apparatus according to claim 22, wherein each said phase element includes at least one impedance or is connected to a respectively other phase element via an impedance.

28. The apparatus according to claim 22, wherein said at least one converter is connected in parallel with a transmission system or with a DC voltage line.

29. The apparatus according to claim 22, wherein said at least one converter is connected in series to a transmission system or to a DC voltage line.

30. The apparatus according to claim 22, wherein each said converter is connected to a DC voltage source.

31. The apparatus according to claim 30, wherein the DC voltage source is a rectifying converter.

32. The apparatus according to claim 31, wherein said rectifying converter is connected to at least two converters.

33. The apparatus according to claim 32, wherein said converters are connected directly to one another, forming a back-to-back link.

34. The apparatus according to claim 32, which comprises a DC voltage line connecting said converters to one another.

35. The apparatus according to claim 34, wherein said DC voltage line has one or two poles.

36. The apparatus according to claim 34, wherein, at least in portions thereof, said DC voltage line is a gas-insulated transmission line, a cable, and/or a high-tension line.

37. The apparatus according to claim 34, wherein said DC voltage line is an impedance.

38. (canceled)

39. The apparatus according to claim 22, which comprises at least one further diode connected in parallel with said switching elements.

40. The apparatus according to claim 22, wherein said energy storage means comprise one or more capacitors.

41. The apparatus according to claim 22, which comprises a transformer winding connecting said at least two parallel branches of said phase elements to one another.

42. The apparatus according to claim 22, which comprises a parallel branch connection galvanically connecting said at least two parallel branches of said phase elements to one another.
